(19) United States
(12) Patent Application Publication
(10) Pub. No.: US 2010/0010680 A1
(43) Pub. Date: Jan. 14, 2010

(54) AIR CONDITIONING CONTROL DEVICE AND AIR CONDITIONING CONTROL METHOD

(75) Inventors: Atsushi Nishino, Shiga (JP); Satoshi Hashimoto, Shiga (JP)

Correspondence Address: GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka-shi, Osaka (JP)

(21) Appl. No.: 12/374,704

(22) PCT Filed: Jul. 24, 2007
(86) PCT No.: PCT/JP2007/064507

§ 371 Date: Jan. 22, 2009

(30) Foreign Application Priority Data
Jul. 31, 2006 (JP) 2006-208952
Feb. 23, 2007 (JP) 2007-044183

(51) Int. Cl. G05D 7/00; F25D 17/06

(52) U.S. Cl. 700/282; 62/426

(57) ABSTRACT

An air conditioning control device includes an operating-unit specifying unit, an adjacent-unit specifying unit and an adjacent-unit control unit, and collectively controls the operation of an indoor unit group. The operating-unit specifying unit specifies an operating unit to perform an air conditioning operation from the indoor units included in the indoor unit group. The adjacent-unit specifying unit specifies an adjacent unit adjacent to the operating unit from the indoor units included in the indoor unit group. The adjacent-unit control unit causes the adjacent unit to perform an air flow generating operation. This air flow inhibits air conditioned by the air conditioning operation of the operating unit from diffusing from an air conditioning target space.

### TECHNICAL FIELD

The present invention relates to an air conditioning control device and an air conditioning control method that collectively control the operation of an indoor unit group constituted by a plurality of indoor units of an air conditioner that are installed in a single space.

### BACKGROUND ART

Conventionally, when air conditioning is performed in a single large open space such as an office, restaurant, and the like, a plurality of indoor units may be installed in such a space. Usually, the operation of each indoor unit can be individually set. Therefore, when a plurality of indoor units are installed in a single large open space and if air conditioning is needed only in the space of a portion of such a single large open space, among all the indoor units installed in the single large open space, only the indoor unit arranged for the space of the portion is caused to perform an air conditioning operation.

Meanwhile, patent document 1 discloses an air curtain generating device that generates an air curtain for separating the space to be targeted by an air conditioning operation from other spaces in order to improve the air conditioning operational efficiency in the space to be targeted by the air conditioning operation.

<Patent Document 1> JP-A Publication No. H6-323594

### DISCLOSURE OF THE INVENTION

### <Object to be Achieved by the Present Invention>

However, when only the space of a portion of a single large open space is to be air conditioned by an indoor unit arranged for the space of the portion, air conditioned by the indoor unit arranged for the space of the portion diffuses into a nearby space. As a result, a space where air conditioning is not needed may be air conditioned.

When an attempt to introduce an air curtain generating device such as the one described in patent document 1 is made in order to separate the space of the portion as described above, it will create new problems such as difficulty in securing an installation space, high cost, and the like. In addition, even if these problems were overcome, if the location of the space to be separated cannot be determined in advance, it is impossible to specify the location where the air curtain generating device should be introduced. Thus, in practice, it is quite difficult to introduce the air curtain generating device.

An object of the present invention is to improve the air conditioning operational efficiency in the space of a portion of a single space having an indoor unit group installed when air conditioning is needed only in the space of the portion, and to facilitate energy conservation.

<means to Achieve the Object>

An air conditioning control device according to a first aspect of the present invention includes an operating-unit specifying unit, an adjacent-unit specifying unit, an operating-unit control unit, and an adjacent-unit control unit, and collectively controls the operation of an indoor unit group. The indoor unit group is constituted by a plurality of indoor units of an air conditioner that are installed in a single space. The operating-unit specifying unit specifies, among the indoor units included in the indoor unit group, an operating unit that is an indoor unit to perform an air conditioning operation. The adjacent-unit specifying unit specifies, among the indoor units included in the indoor unit group, an adjacent unit that is an indoor unit adjacent to the operating unit. The operating-unit control unit causes the operating unit to perform the air conditioning operation. The adjacent-unit control unit causes the adjacent unit to perform an air flow generating operation. The air flow generating operation is an operation to generate an air flow. This air flow inhibits air conditioned by the air conditioning operation of the operating unit from diffusing from an air conditioning target space. The air conditioning target space is a portion of a single space where the indoor unit group is installed, and is a space which is targeted by the air conditioning operation of the operating unit.

With this air conditioning control device, an indoor unit (operating unit) capable of air conditioning a space required to be air conditioned (air conditioning target space) within a single space where the plurality of indoor units are installed is caused to perform the air conditioning operation. Further, this air conditioning control device causes an indoor unit (adjacent unit) adjacent to the operating unit to perform the air flow generating operation. Note that the adjacent unit may be located either inside or outside the air conditioning target space. The adjacent unit performs the air flow generating operation and thereby generates an air flow that inhibits conditioned air from diffusing from the air conditioning target space. Accordingly, with this air conditioning control device, when air conditioning is needed only in the space of a portion of a single space having the indoor unit group installed, it is possible to improve the air conditioning operational efficiency in the space of the portion and facilitate energy conservation.

An air conditioning control device according to a second aspect of the present invention is the air conditioning control device according to the first aspect of the present invention, wherein the air flow generating operation is a thermo-off operation.

This air conditioning control device causes the adjacent unit to perform the thermo-off operation as the air flow generating operation, i.e., an operation in an air blowing mode where only blowing of air is performed. Accordingly, with this air conditioning control device, it is possible to generate an air flow that inhibits conditioned air from diffusing from the air conditioning target space.

An air conditioning control device according to a third aspect of the present invention is the air conditioning control device according to the first aspect of the present invention, wherein the air flow generating operation is a mild cooling operation or a mild heating operation.

This air conditioning control device causes the adjacent unit to perform the mild cooling operation or the mild heating operation as the air flow generating operation. Accordingly, with this air conditioning control device, it is possible to aid the cooling operation or the heating operation of the operating unit while inhibiting conditioned air from diffusing from the air conditioning target space, by generating an air flow of air mildly cooled or mildly heated.

An air conditioning control device according to a fourth aspect of the present invention is the air conditioning control device according to any one of the first through third aspects of the present invention, wherein the adjacent unit is installed in a ceiling of the space where the indoor unit group is installed. The air flow generating operation is an air blowing operation to blow air downward or obliquely downward.

This air conditioning control device causes the adjacent unit to blow air downward or obliquely downward as the air flow generating operation. Accordingly, with this air conditioning control device, an air curtain is formed at a boundary between the air conditioning target space and the space outside thereof, and it is possible to more effectively inhibit conditioned air from diffusing from the air conditioning target space.

An air conditioning control device according to a fifth aspect of the present invention is the air conditioning control device according to any one of the first through fourth aspects of the present invention, further including an operation command input unit. The operation command input unit allows a user to input an operation command to the indoor units included in the indoor unit group. The operating-unit specifying unit specifies the operating unit based on the operation command input via the operation command input unit.

With this air conditioning control device, the operating unit is specified based on the operation command input by the user via the operation command input unit. The operation command input unit may be, for example, an individual remote controller for controlling each indoor unit or a central remote controller for controlling a plurality of indoor units. Accordingly, with this air conditioning control device, the operating unit can manually be specified by the user.

An air conditioning control device according to a sixth aspect of the present invention is the air conditioning control device according to any one of the first through fourth aspects of the present invention, further including a living body location identifying unit. The living body location identifying unit identifies the location of a living body present in the space where the indoor unit group is installed. The operating-unit specifying unit specifies the operating unit based on the location of the living body identified by the living body location identifying unit.

With this air conditioning control device, the operating unit is specified based on the location of a living body present in the space where the indoor unit group is installed, which is identified by the living body location identifying unit. Accordingly, with this air conditioning control device, it is possible to automatically specify the operating unit.

An air conditioning control device according to a seventh aspect of the present invention is the air conditioning control device according to any one of the first through sixth aspects of the present invention, wherein the adjacent unit includes a plurality of air blow-out direction adjusting means. The air blow-out direction adjusting means adjust the direction of air blown out from the adjacent unit. The air flow generating operation is an operation to generate the above described air flow by independently controlling the plurality of air blow-out direction adjusting means such that air is blown out from the adjacent unit only in the direction toward the air conditioning target space.

The adjacent unit controlled by this air conditioning control device is equipped with the plurality of air blow-out direction adjusting means capable of being operated in a mutually independent manner. The air blow-out direction adjusting means are, for example, flaps that open and close a blow-out port formed in a casing of the indoor unit. This air conditioning control device causes the adjacent unit to blow out air only in the direction from the adjacent unit toward the air conditioning target space by separately controlling the plurality of air blow-out direction adjusting means, and inhibits the adjacent unit from blowing air in directions not toward the air conditioning target space. Accordingly, with this air conditioning control device, it is possible to further facilitate energy conservation by inhibiting the adjacent unit from unnecessarily blowing air.

An air conditioning control device according to an eighth aspect of the present invention is the air conditioning control device according to any one of the first through seventh aspects of the present invention, wherein, when a plurality of indoor units are specified as the operating units by the operating-unit specifying unit, the adjacent-unit specifying unit specifies only an indoor unit that is not the operating unit as the adjacent unit, among all the indoor units adjacent to at least one of the operating units. Among the plurality of indoor units specified as the operating units by the operating-unit specifying unit, the operating-unit control unit causes the indoor unit adjacent to the adjacent unit to perform the air conditioning operation at reduced performance level compared to the other indoor units not adjacent to the adjacent unit.

Air in a space that is inside the air conditioning target space and that is near the boundary between the air conditioning target space and the space outside thereof tends to easily flow out of the air conditioning target space. Consequently, with this air conditioning control device, among all the indoor units arranged for the air conditioning target space, the indoor unit arranged for the space near the boundary is caused to perform an air conditioning operation at reduced performance level compared to the indoor unit arranged for the space that is more inward than the space near the boundary. Accordingly, with this air conditioning control device, it is possible to improve the air conditioning operational efficiency in the air conditioning target space.

An air conditioning control device according to a ninth aspect of the present invention is the air conditioning control device according to any one of the first through eighth aspects of the present invention, further including a memory unit. The memory unit stores arrangement information. The arrangement information is information regarding the arrangement of the indoor units included in the indoor unit group in the space where the indoor unit group is installed. The adjacent-unit specifying unit specifies the adjacent unit based on the arrangement information stored in the memory unit.

This air conditioning control device stores the arrangement information of the indoor units constituting the indoor unit group. Accordingly, with this air conditioning control device, the adjacent unit among the indoor units can be specified.

An air conditioning control device according to a tenth aspect of the present invention is the air conditioning control device according to the first aspect of the present invention, wherein the operating unit and the adjacent unit are present in the air conditioning target space.

This air conditioning control device causes the adjacent unit that is an indoor unit in the air conditioning target space to perform the air flow generating operation. In other words, it is possible to further facilitate energy conservation by not allowing the adjacent unit to perform a normal air conditioning operation.

An air conditioning control device according to an eleventh aspect of the present invention is the air conditioning control device according to the tenth aspect of the present invention, wherein the operating-unit control unit causes the operating unit to perform a cooling operation. The adjacent-unit control unit controls the direction of air from the adjacent unit so as to be directed toward a living body in the vicinity of the adjacent unit.

During the cooling operation of the operating unit, this air conditioning control device causes the adjacent unit to blow out air in the direction toward the living body in the vicinity of the adjacent unit. Therefore, even if the temperature in the space in the vicinity of the adjacent unit is raised as a result of the adjacent unit not performing the normal air conditioning operation, the sensible temperature as felt by the living body in the vicinity of the adjacent unit can be lowered.

An air conditioning control device according to a twelfth aspect of the present invention is the air conditioning control device according to the tenth aspect of the present invention, wherein the adjacent unit is installed in a ceiling of the space. The operating-unit control unit causes the operating unit to perform the cooling operation. The operating-unit control unit controls the direction of air from the operating unit so as to be directed toward the adjacent unit.

This air conditioning control device causes the operating unit to blow out cold air toward the adjacent unit arranged in the ceiling. Accordingly, in the air conditioning target space, heavy cold air is accumulated near the ceiling and the cold air gradually descends to near the floor. Thus, it is possible to uniformly cool the air conditioning target space.

An air conditioning control device according to a thirteenth aspect of the present invention is the air conditioning control device according to the tenth aspect of the present invention, wherein the adjacent unit has a suction port for sucking air and a plurality of air blow-out direction adjusting means. The air blow-out direction adjusting means adjust the direction of air blown out. The air flow generating operation is an operation to generate the air flow only from the air blow-out direction adjusting means farther from the operating unit than the suction port, among the plurality of air blow-out direction adjusting means.

The adjacent unit controlled by this air conditioning control device is equipped with the plurality of air blow-out direction adjusting means capable of being operated in a mutually independent manner. The air blow-out direction adjusting means are, for example, flaps that open and close a blow-out port formed in a casing of the indoor unit. This air conditioning control device generates the air flow only from the air blow-out direction adjusting means located at a position far from the operating unit compared to the suction port, and inhibits air from being blown out from the air blow-out direction adjusting means located at a position close to the operating unit compared to the suction port, among the plurality of blow-out direction adjusting means. Accordingly, with this air conditioning control device, air conditioned by the operating unit can easily reach the space in the vicinity of the adjacent unit.

An air conditioning control method according to a fourteenth aspect of the present invention includes an operating unit specifying step, an adjacent unit specifying step, a first controlling step, and a second controlling step, and collectively controls the operation of an indoor unit group. The indoor unit group is constituted by a plurality of indoor units of an air conditioner that are installed in a single space. The operating unit specifying step specifies an operating unit that is an indoor unit to perform an air conditioning operation, among the indoor units included in the indoor unit group. The adjacent unit specifying step specifies, among the indoor units included in the indoor unit group, an adjacent unit that is an indoor unit adjacent to the operating unit. The first controlling step causes the operating unit to perform the air conditioning operation. The second controlling step causes the adjacent unit to perform an air flow generating operation. The air flow generating operation is an operation to generate an air flow. This air flow inhibits air conditioned by the air conditioning operation of the operating unit from diff-using from an air conditioning target space. The air conditioning target space is a portion of a single space where the indoor unit group is installed, and is a space which is targeted by the air conditioning operation of the operating unit.

With this air conditioning control method, an indoor unit (operating unit) capable of air conditioning a space required to be air conditioned (air conditioning target space) within a single space where a plurality of indoor units are installed is caused to perform the air conditioning operation. Additionally, with this air conditioning control method, an indoor unit (adjacent unit) adjacent to the operating unit is caused to perform the air flow generating operation. Note that the adjacent unit may be located either inside or outside the air conditioning target space. The adjacent unit performs the air flow generating operation and thereby generates an air flow that inhibits conditioned air from diff-using from the air conditioning target space. Accordingly, with this air conditioning control method, when air conditioning is needed only in the space of a portion of a single space having the indoor unit group installed, it is possible to improve the air conditioning operational efficiency in the space of the portion and facilitate energy conservation.

### <Effects of the Invention>

With the air conditioning control device according to the first aspect of the present invention, when air conditioning is needed only in the space of a portion of a single space having the indoor unit group installed, it is possible to improve the air conditioning operational efficiency in the space of the portion and facilitate energy conservation.

With the air conditioning control device according to the second aspect of the present invention, it is possible to generate an air flow that inhibits conditioned air from diffusing from the air conditioning target space.

With the air conditioning control device according to the third aspect of the present invention, it is possible to aid the cooling operation or the heating operation of the operating unit while inhibiting conditioned air from diff-using from the air conditioning target space, by generating an air flow of air mildly cooled or mildly heated.

With the air conditioning control device according to the fourth aspect of the present invention, an air curtain is formed at a boundary between the air conditioning target space and the space outside thereof, and it is possible to more effectively inhibit conditioned air from diffusing from the air conditioning target space.

With the air conditioning control device according to the fifth aspect of the present invention, the operating unit can manually be specified by the user.

With the air conditioning control device according to the sixth aspect of the present invention, the operating unit can be automatically specified.

With the air conditioning control device according to the seventh aspect of the present invention, it is possible to further facilitate energy conservation by inhibiting the adjacent unit from unnecessarily blowing air.

With the air conditioning control device according to the eighth aspect of the present invention, it is possible to improve the air conditioning operational efficiency in the air conditioning target space.

With the air conditioning control device according to the ninth aspect of the present invention, the adjacent unit among the indoor units can be specified.

With the air conditioning control device according to the tenth aspect of the present invention, it is possible to further facilitate energy conservation by not allowing the adjacent unit to perform the normal air conditioning operation.

With the air conditioning control device according to the eleventh aspect of the present invention, even if the temperature in the space in the vicinity of the adjacent unit is raised as a result of the adjacent unit not performing the normal air conditioning operation, the sensible temperature as felt by the living body in the vicinity of the adjacent unit can be lowered.

With the air conditioning control device according to the twelfth aspect of the present invention, it is possible to uniformly cool the air conditioning target space.

With the air conditioning control device according to the thirteenth aspect of the present invention, air conditioned by the operating unit can easily reach the space in the vicinity of the adjacent unit.

With the air conditioning control method according to the fourteenth aspect of the present invention, when air conditioning is needed only in the space of a portion of a single space having the indoor unit group installed, it is possible to improve the air conditioning operational efficiency in the space of the portion and facilitate energy conservation.

### BRIEF DESCRIPTION OF THE DRAWINGS

FIG. 1 is a view showing the setting of an indoor space where indoor units of an air conditioner controlled by an air conditioning control device according to a first embodiment of the present invention are installed.

FIG. 2 is a block diagram showing a configuration of the air conditioning control device according to the first embodiment of the present invention.

FIG. 3 is a view showing an arrangement information management table according to the first embodiment of the present invention.

FIG. 4 is a view showing a configuration of the air conditioner according to the first embodiment of the present invention.

FIG. 5 is an external view of the indoor unit according to the first embodiment of the present invention.

FIG. 6 is a flowchart showing the flow of the process in which the air conditioning control device according to the first embodiment of the present invention controls the indoor units.

FIG. 7 is a view showing the setting of the indoor space to which air conditioning control according to the first embodiment of the present invention is being applied.

FIG. 8 is a view showing an arrangement information management table according to an alternative embodiment (4) of the first embodiment of the present invention.

FIG. 9 is a view showing the setting of an indoor space where indoor units of an air conditioner controlled by an air conditioning control device according to a second embodiment of the present invention are installed.

FIG. 10 is a block diagram showing a configuration of the air conditioning control device according to the second embodiment of the present invention.

FIG. 11 is a view showing a configuration of the air conditioner according to the second embodiment of the present invention.

FIG. 12 is an external view of the indoor unit according to the second embodiment of the present invention.

FIG. 13 is a flowchart showing the flow of the process in which the air conditioning control device according to the second embodiment of the present invention controls the indoor units.

FIG. 14 is a view showing the setting of the indoor space to which air conditioning control according to the second embodiment of the present invention is being applied.

FIG. 15(a) is a view showing the setting of the indoor space to which air conditioning control according to an alternative embodiment (3) of the second embodiment of the present invention is being applied.

FIG. 15(b) is a view showing a different setting of the indoor space to which air conditioning control according to the alternative embodiment (3) of the second embodiment of the present invention is being applied.

FIG. 16 is a view showing the setting of the indoor space to which air conditioning control according to an alternative embodiment (5) of the second embodiment of the present invention is being applied.

FIG. 17 is a view showing the setting of the indoor space to which air conditioning control according to an alternative embodiment (7) of the second embodiment of the present invention is being applied.

### DESCRIPTION OF THE REFERENCE SYMBOLS

1, 101 Air conditioning control device
10 Control unit
11, 111 Operating-unit specifying unit
12, 112 Adjacent-unit specifying unit
13, 113 Operating-unit control unit
14, 114 Adjacent-unit control unit
20 Memory unit
21, 22 Arrangement information management table (arrangement information)
30a, 30b, . . . , 30y Indoor units
30f to 30h, 30k to 30m, 30p to 30r Operating units
30a to 30c, 30i, 30n,
30s, 30u to 30w Adjacent units
31a to 31d Flaps (air blow-out direction adjusting means)
33 Suction port
40a, 40b, . . . , 40y Remote controllers
121 Arrangement information
130a, 130b, . . . , 130y Indoor units
130k, 130l Operating units
130f to 130h, 130m, 130p to 130r Adjacent units
A, B Indoor space
M, N Air conditioning target space

### BEST MODE FOR CARRYING OUT THE INVENTION

### First Embodiment

An air conditioning control device 1 according to a first embodiment of the present invention is described below.

<Installation Environment of Air Conditioning Control Device>

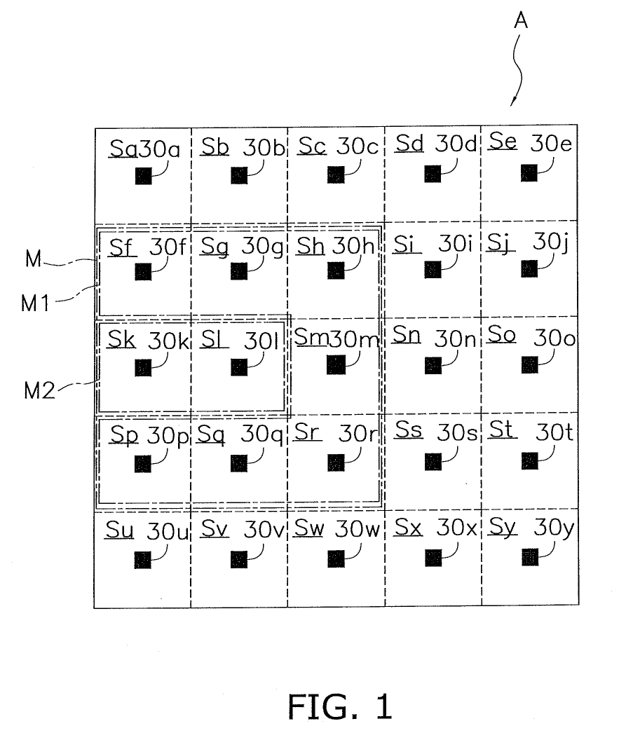

FIG. 1 shows the setting of an indoor space A where indoor units 30a, 30b, . . . , and 30y of an air conditioner controlled by the air conditioning control device 1 are installed. The indoor space A is a single large open space such as an office, restaurant, and the like.

In the ceiling of the indoor space A, the plurality of indoor units 30a, 30b, . . . , and 30y are embedded at appropriate intervals. In FIG. 1, cell spaces Sa, Sb, . . . , and Sy partitioned by broken lines are spaces that are virtually divided, and correspond to respectively the indoor units 30a, 30b, . . . , and 30y. The cell spaces Sa, Sb, . . . , and Sy are spaces which is targeted by an air conditioning operation of the indoor units 30a, 30b, . . . , and 30y respectively. The indoor units 30a, 30b, . . . , and 30y are installed inside of the cell spaces Sa, Sb, . . . , and Sy respectively.

<Configuration of Air Conditioning Control Device>

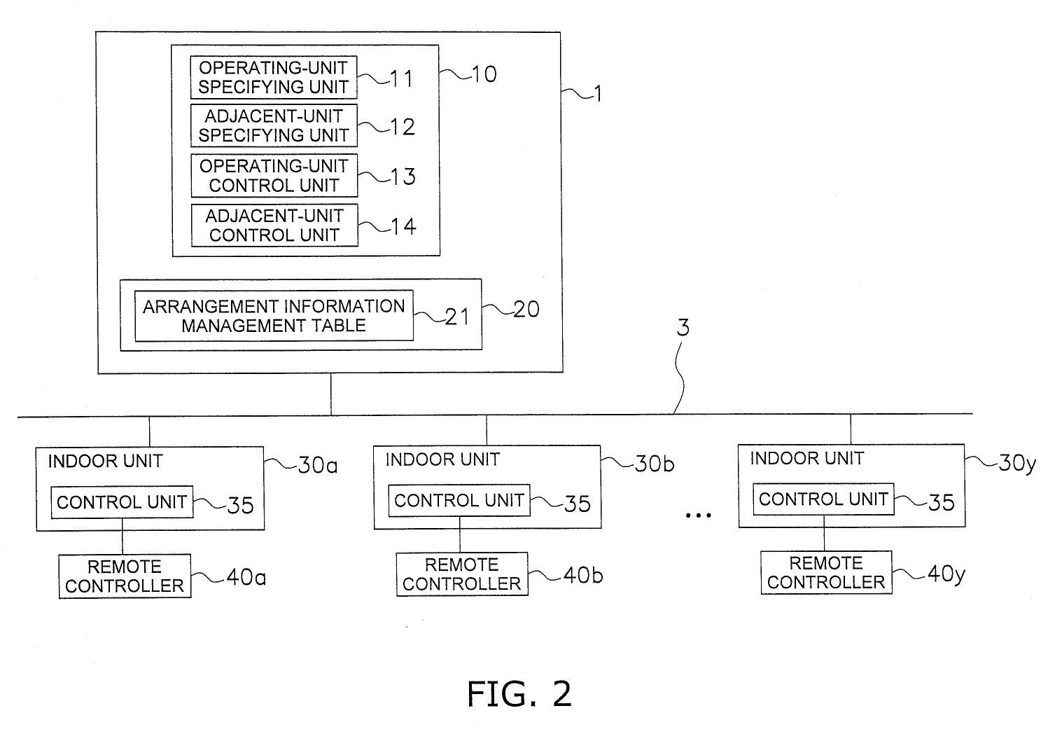

FIG. 2 is a block diagram showing the configuration of the air conditioning control device 1. The air conditioning control device 1 has a control unit 10 and a memory unit 20. The air conditioning control device 1 is connected to a control unit 35 of each of the indoor units 30a, 30b, . . . , and 30y via a communication network 3, and is capable of controlling the operation of each portion of each of the indoor units 30a, 30b, . . . , and 30y via the control unit 35. This communication network 3 may be a network dedicated to air conditioning to which only the air conditioning control device 1 and equipment such as the indoor units 30a, 30b, . . . , and 30y are connected, or may be a general network compliant with standards such as Ethernet (registered trademark).

By reading out and executing a control program stored in the memory unit 20, the control unit 10 operates as an operating-unit specifying unit 11, an adjacent-unit specifying unit 12, an operating-unit control unit 13, an adjacent-unit control unit 14 and the like. Details of the operation of each of these units 11 to 14 are described later.

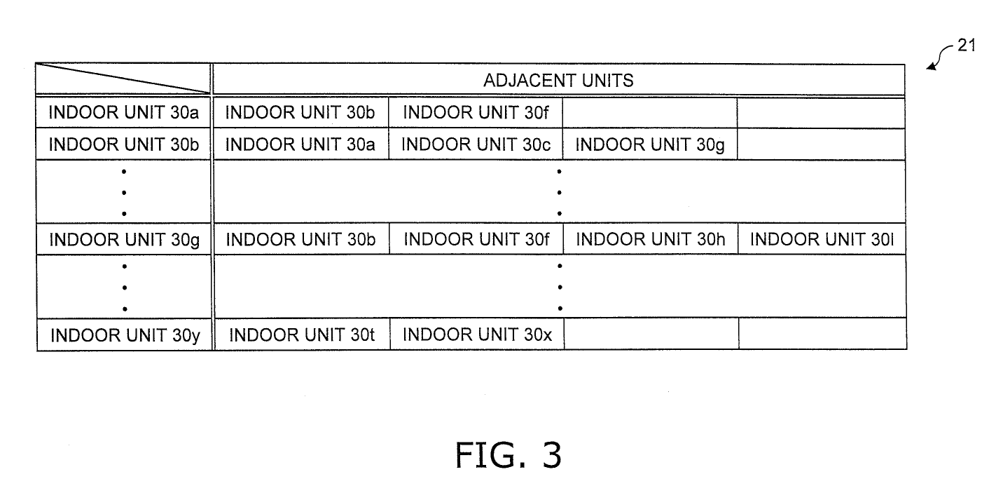

The memory unit 20 stores an arrangement information management table 21 that organizes information regarding the arrangement of the indoor units 30a, 30b, . . . , and 30y in the indoor space A. As shown in FIG. 3, the arrangement information management table 21 manages information as one line data that associates each one of the indoor units 30a, 30b, . . . , and 30y with a maximum of four indoor units 30a, 30b, . . . , and 30y adjacent to the one of the indoor units 30a, 30b, . . . , and 30y.

### <Configuration of Air Conditioner>

The indoor unit 30a is mainly described below; however, the same description applies to other indoor units 30b, . . . , 30y.

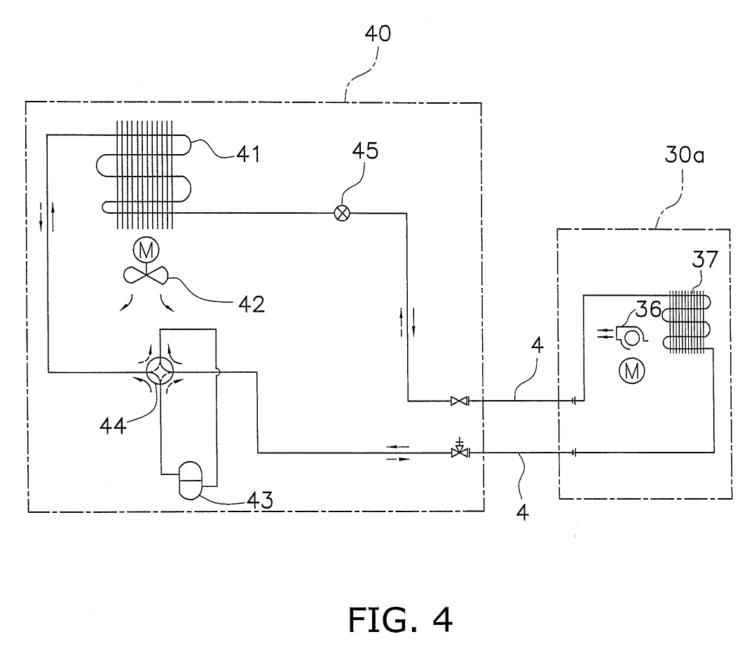

As shown in FIG. 4, the indoor unit 30a is connected to an outdoor unit 40 via a refrigerant communication pipe 4. Note that the air conditioner controlled by the air conditioning control device 1 is a multi system air conditioner and the indoor units 30a, 30b, . . . , and 30y are connected in parallel; however, the illustrations thereof are omitted in FIG. 4 for the sake of simplicity.

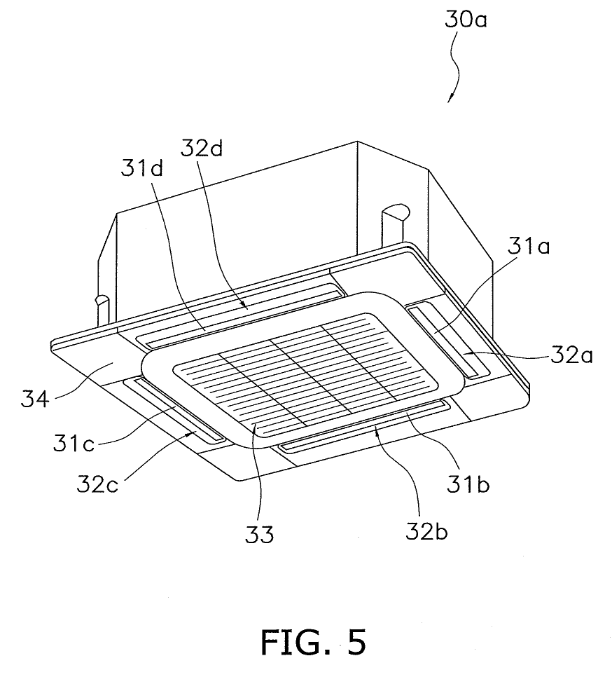

An indoor fan 36 rotationally driven by a fan motor is provided in a casing of the indoor unit 30a, and air in the cell space Sa is sucked into the casing of the indoor unit 30a via a suction port 33 (see FIG. 5) as a result of rotation of the indoor fan 36. The air sucked into the casing of the indoor unit 30a exchanges heat with the refrigerant flowing through an indoor side heat exchanger 37 disposed in the casing of the indoor unit 30a. Consequently, the air is cooled during operation in a cooling mode (when a four way valve 44 of the outdoor unit 40 is in a state shown by solid lines) and is heated during operation in a heating mode (when the four way valve 44 of the outdoor unit 40 is in a state shown by broken lines).

On the other hand, the refrigerant that has exchanged heat in the indoor side heat exchanger 37 is sent to the outdoor unit 40 via the refrigerant communication pipe 4. In a casing of the outdoor unit 40, there are provided an outdoor side heat exchanger 41, an outdoor fan 42, a compressor 43, a four way valve 44, and an expansion valve 45. As a result of the outdoor fan 42 being rotationally driven by the fan motor, outdoor air is sucked into the casing of the outdoor unit 40, and heat exchange is facilitated between the air sucked into and the refrigerant flowing through the outdoor side heat exchanger 41. The refrigerant flowing through the outdoor side heat exchanger 41 radiates heat during operation in the cooling mode (when the four way valve 44 of the outdoor unit 40 is in a state shown by solid lines) and absorbs heat during operation in the heating mode (when the four way valve 44 of the outdoor unit 40 is in a state shown by broken lines).

FIG. 5 is an external view of the indoor unit 30a. The suction port 33 for sucking air in the cell space Sa and four blow-out ports 32a to 32d for blowing out air into the cell space Sa are formed in a bottom panel 34 of the casing of the indoor unit 30a. The bottom panel 34 is a decorative panel facing the indoor space A, and has a generally quadrangular shape. The four blow-out ports 32a to 32d are formed one each along the four sides of the generally quadrangular bottom panel 34, and surround the suction port 33 formed in a generally quadrangular shape in the center of the bottom panel 34. In addition, the bottom panel 34 is provided with flaps 31a to 31d that open and close blow-out ports 32a to 32d, respectively. The flow direction of air blown out from the indoor unit 30a is determined by the inclination of the flaps 31a to 31d.

With reference to FIG. 2 once again, the indoor unit 30a has the control unit 35. The control unit 35 is connected to a motor that opens and closes the flaps 31a to 31d, and can control the opening and closing of the flaps 31a to 31d. In addition, the control unit 35 is connected to the fan motor that rotationally drives the indoor fan 36, and can control the rotation speed of the indoor fan 36. Further, the control unit 35 can communicate with a remote controller 40a in a wire or wireless manner. The user can input operation commands such as on/off of the operation, operation mode, set temperature, air volume, direction of air, and the like to the indoor unit 30a via the remote controller 40a. Note that, although FIG. 2 illustrates the remote controllers 40a, 40b, . . . , and 40y being provided respectively correspondingly to the indoor units 30a, 30b, . . . , and 30y, any number of remote controllers may be provided in other embodiments.

<Operation of Air Conditioning Control Device>

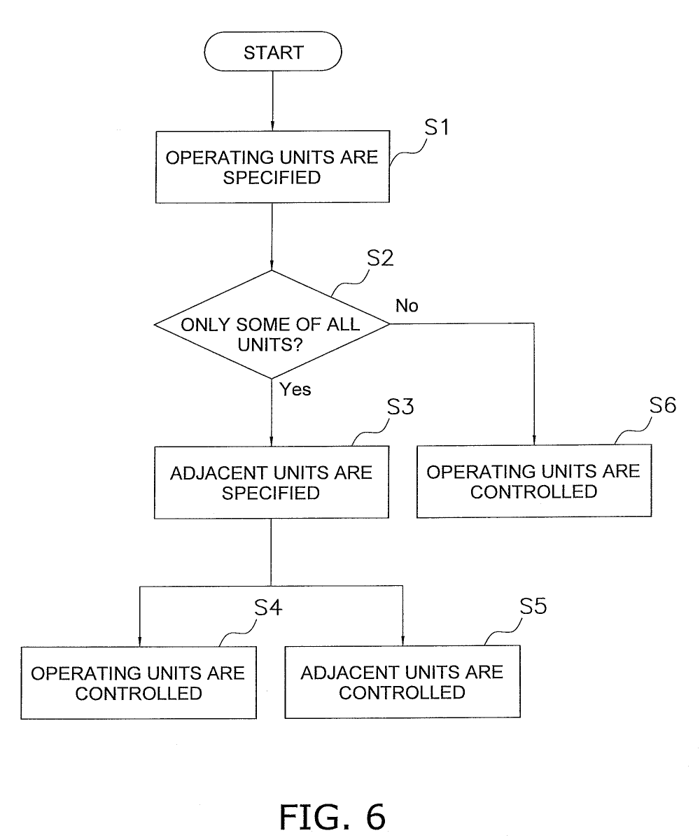

FIG. 6 is a flowchart showing the flow of the process in which the air conditioning control device 1 controls the indoor units 30a, 30b, . . . , and 30y of the air conditioner. This process is started when the user started or stopped any type of operation of the indoor units 30a, 30b, . . . , and 30y via the remote controllers 40a, 40b, . . . , and 40y (note that an operation in an air blowing mode where only blowing of air is performed is excluded, and the same applies throughout to the description of the first embodiment unless otherwise explicitly stated). The operation commands input into the remote controllers 40a, 40b, . . . , and 40y by the user are sent to the control unit 10 of the air conditioning control device 1 via the control unit 35 of the indoor units 30a, 30b, . . . , and 30y, respectively, and the communication network 3.

The process shown in FIG. 6 is described below by taking, as a specific example, the case in which the user requires air conditioning only in a space M (see FIG. 1) constituted by the cell spaces Sf to Sh, Sk to Sm, and Sp to Sr within the indoor space A. In this specific example, the user selects the operation of the indoor units 30f to 30h, 30k to 30m, and 30p to 30r installed in the space M, among all the indoor units 30a, 30b, . . . , and 30y installed in the indoor space A, via the remote controllers 40a, 40b, . . . , and 40y. In other words, the space M is an air conditioning target space where the user requires air conditioning. For example, the space M is an occupied space where the user is present, and the cell spaces Sa to Se, Si, Sj, Sn, So, Ss, St, and Su to Sy that are not included in the space M are vacant spaces where the user is not present.

In step S1, the control unit 10 operates as the operating-unit specifying unit 11. Based on the operation commands sent from the remote controllers 40a, 40b, . . . , and 40y, the operating-unit specifying unit 11 specifies, among all the indoor units 30a, 30b, . . . , and 30y, the indoor units 30f to 30h, 30k to 30m, and 30p to 30r being currently selected by the user to operate (hereinafter referred to as “operating units”).

Next, in step S2, the control unit 10 determines whether or not the operating units 30f to 30h, 30k to 30m, and 30p to 30r specified in step S1 are only some of all the indoor units 30a, 30b, . . . , and 30y. When they are only some of all, in other words, when only some of all indoor units are currently selected by the user to operate, the process proceeds to step S3, otherwise to step S6. In case of the above described specific example, the process proceeds to step S3.

In step S3, the control unit 10 operates as the adjacent-unit specifying unit 12. The adjacent-unit specifying unit 12 specifies the indoor units 30a to 30c, 30i, 30n, 30s, and 30u to 30w (hereinafter referred to as “adjacent units”) adjacent to the operating units 30f to 30h, 30k to 30m, and 30p to 30r specified in step SI. Note that the indoor units specified as the adjacent units in step S3 are the indoor units 30a to 30c, 30i, 30n, 30s, and 30u to 30w that are not the operating units 30f to 30h, 30k to 30m, and 30p to 30r, among all the indoor units 30a to 30c, 30f to 30i, 30k to 30n, 30p to 30s, and 30u to 30w adjacent to any of the operating units 30f to 30h, 30k to 30m, and 30p to 30r. More specifically, the adjacent-unit specifying unit 12 refers to the arrangement information management table 21 stored in the memory unit 20 and specifies all the indoor units 30a to 30c, 30f to 30i, 30k to 30n, 30p to 30s, and 30u to 30w adjacent to any of the operating units 30f to 30h, 30k to 30m, and 30p to 30r. Then, the adjacent-unit specifying unit 12 excludes the operating units 30f to 30h, 30k to 30m, and 30p to 30r from all the specified indoor units 30a to 30c, 30f to 30i, 30k to 30n, 30p to 30s, and 30u to 30w so as to specify the adjacent units 30a to 30c, 30i, 30n, 30s, and 30u to 30w. Note that the adjacent units 30a to 30c, 30i, 30n, 30s, and 30u to 30w are present in an adjacent space (cell spaces Sa to Sc, Si, Sn, Ss, and Su to Sw) adjacent to the space M. The adjacent space (cell spaces Sa to Sc, Si, Sn, Ss, and Su to Sw) is included in the cell spaces Sa to Se, Si, Sj, Sn, So, Ss, St, and Su to Sy that are not the air conditioning target spaces.

After step S3, the process proceeds to step S4 and step S5. Step S4 and step S5 are concurrently executed.

In step S4, the control unit 10 operates as the operating-unit control unit 13. The operating-unit control unit 13 divides the space M where the user requires air conditioning into two blocks. The two blocks are: a boundary side space M1 that defines the boundary between the space M and the space outside thereof (cell spaces Sa to Se, Si, Sj, Sn, So, Ss, St, and Su to Sy); and an inner space M2 surrounded by the boundary side space M1. The operating-unit control unit 13 controls the indoor units 30k and 301 in the inner space M2 according to settings of the operation mode, set temperature, air volume, direction of air, and the like that were input by the user via the remote controllers 40a, 40b, . . . , and 40y. On the other hand, the operating-unit control unit 13 controls the indoor units 30f to 30h, 30m, 30p to 30r in the boundary side space M1 such that the settings input by the user via the remote controllers 40a, 40b, . . . , and 40y are performed at a lower performance level. For example, control is performed such that the set temperature is raised by a predetermined amount in the case of the cooling operation mode and is lowered by a predetermined amount in the case of the heating mode, and the air volume is decreased by a predetermine level.

In this way, in this step S4, air in the boundary side space M1 which tends to easily diffuse into a space where the user does not require air conditioning (cell spaces 30a to 30e, 30i, 30j, 30n, 30o , and 30s to 30y ) is conditioned at a lower performance level, and thereby it is possible to achieve energy conservation.

In addition, in step S5, the control unit 10 operates as the adjacent-unit control unit 14. The adjacent-unit control unit 14 causes the adjacent units 30a to 30c, 30i, 30n, 30s, and 30u to 30w specified in step S3 to perform a thermo-off operation, i.e., an operation in the air blowing mode where only blowing of air is performed. At this time, the direction of air from the adjacent units 30a to 30c, 30i, 30n, 30s, and 30u to 30w is downward or obliquely downward in the direction toward the outside of the adjacent units 30a to 30c, 30i, 30n, 30s, and 30u to 30w, or the direction of air is set to a swing mode where the air swings between these directions. Note that a specific angle of the “obliquely downward” direction as referred to herein may be predetermined based on the distances among the indoor units 30a, 30b, and 30y, or may be automatically calculated by referring to the memory unit 20 in which information regarding these distances are stored in advance. Or, the direction of air from the adjacent units may be determined according to the setting of the operating units 30f to 30h, 30k to 30m, and 30p to 30r. For example, if the setting of the operating units 30f to 30h, 30k to 30m, and 30p to 30r is “downward”, the direction of air from the adjacent units is adjusted to be more downward. Further, the air volume of the adjacent units may be uniformly set to, for example, “strong” or may be determined according to the setting of the operating units 30f to 30h, 30k to 30m, and 30p to 30r. For example, if the setting of the operating units 30f to 30h, 30k to 30m, and 30p to 30r is “strong,” the air volume of the adjacent units may be set to “strong”, and if the setting of the operating units 30f to 30h, 30k to 30m, and 30p to 30r is “weak,” the air volume of the adjacent units may be set to “weak”.

Accordingly, in this step S5, it is possible to inhibit air conditioned by the operating units 30f to 30h, 30k to 30m, and 30p to 30r in the space M where the user requires air conditioning from diffusing from the space M where the user requires air conditioning.

Note that the indoor units 30d, 30e, 30j, 30o, 30t, 30x, and 30y that are neither the operating units 30f to 30h, 30k to 30m, and 30p to 30r specified by the operating-unit specifying unit 11 nor the adjacent units 30a to 30c, 30i, 30n, 30s, and 30u to 30w specified by the adjacent-unit specifying unit 12 are held in the OFF state unless the operation in the air blowing mode is selected by the user.

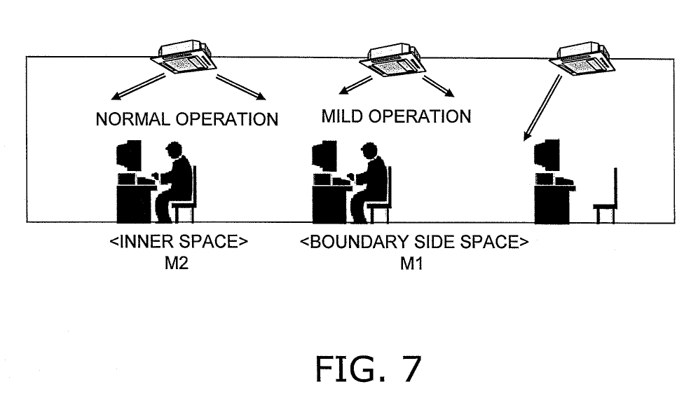

FIG. 7 is a view showing the setting of the indoor space A during execution of step S4 and step S5 in the above described specific example.

Note that when the process proceeds to step S6 after step S2, each of the indoor units 30a, 30b, . . . , and 30y in the indoor space A will be controlled according to the settings of the operation mode, set temperature, air volume, direction of air, and the like that were input by the user via the remote controllers 40a, 40b, . . . , and 40y.

<Characteristics>

In the above embodiment, when the user commands that only some indoor units 30f to 30h, 30k to 30m, and 30p to 30r should perform the air conditioning operation in the single large open indoor space A where the plurality of indoor units 30a, 30b, . . . , and 30y are installed, the indoor units 30a to 30c, 30i, 30n, 30s, and 30u to 30w that surround those some indoor units 30f to 30h, 30k to 30m, and 30p to 30r perform the air blowing operation, and thereby the space M that should be air conditioned will be enveloped by an air curtain. Accordingly, conditioned air is inhibited from diff-using from the space M that should be air conditioned, and thereby it is possible to achieve energy conservation.

### Alternative Embodiments>

(1)

In the above embodiment, in step S4 in FIG. 6, the space M where the user requires air conditioning is divided into two blocks (the boundary side space M1 and the inner space M2), and a different type of control is performed for each block; however, such control may be omitted. In other words, the entire space M may be controlled according to the settings that were input by the user via the remote controllers 40a, 40b, . . . , and 40y.

(2)

In the above embodiment, in step S5 in FIG. 6, the adjacent units 30a to 30c, 30i, 30n, 30s, and 30u to 30w are controlled to perform the thermo-off operation; however, they may be controlled to perform a mild cooling operation or a mild heating operation. In this case, the mild cooling operation or the mild heating operation of the adjacent units 30a to 30c, 30i, 30n, 30s, and 30u to 30w will aid the cooling operation or the heating operation in the space M where the user requires air conditioning.

(3)

In the above embodiment, a location identifying system capable of automatically detecting the location of a living body such as a person or an animal present in the indoor space A may be introduced. For example, as such a location identifying system, infrared sensors may be installed at several appropriate locations in the indoor space A. Or, a living body in the indoor space A may carry a transmitter, and receivers capable of detecting a signal from the transmitter may be installed in several appropriate locations in the indoor space A. Additionally, as a transmitter, a device such as an IC tag may be used. If a transmitter and receivers are introduced as the location identifying system, the control unit 10 and the like will identify the location of the transmitter by triangulation or other methods based on a signal from the transmitter that was received by the receivers. Further, mainly in the case where the indoor space A is an office or the like, an entering/leaving management system introduced as the location identifying system into the indoor space A, or a personal computer used by an employee working in the indoor space A which allows manual input of information indicating the presence or absence of people may be used by interlocking with the air conditioning control device 1.

In this case, information regarding the location of a living body identified by such a location identifying system is sent to the control unit 10 of the air conditioning control device 1. In step S2 in FIG. 6, the operating-unit specifying unit 11 specifies the operating units based on the information regarding the location of the living body identified by the location identifying system in addition to or instead of the operation commands sent from the remote controllers 40a, 40b, . . . , and 40y. Additionally, in this case, the process in FIG. 6 may be executed in the case where the information regarding the location of the living body is sent to the control unit 10 from the location identifying system in addition to or instead of the case where the operation commands input by the user are sent to the control unit 10 from the remote controllers 40a, 40b, . . . , and 40y.

(4)

In the above embodiment, opening and closing of the flaps 31a to 31d of each of the indoor units 30a, 30b, . . . , and 30y may be independently controllable for each of the flaps 31a to 31d.

In this case, the thermo-off operation of the adjacent units 30a to 30c, 30i, 30n, 30s, and 30u to 30w in step S5 in FIG. 6 may be controlled as described below.

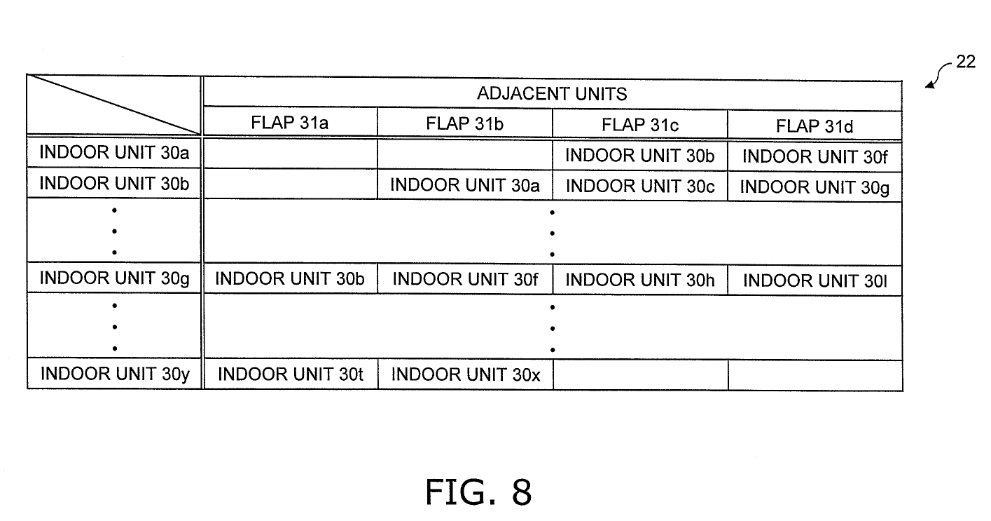

Specifically, among the four flaps 31a to 31d of each of the adjacent units 30a to 30c, 30i, 30n, 30s, and 30u to 30w, the adjacent-unit control unit 14 causes air to be blown out only from the flaps that can direct air to be blown toward the space M for which the operating units 30f to 30h, 30k to 30m, and 30p to 30r are arranged. For example, for each of the adjacent units 30a to 30c, 30i, 30n, 30s, and 30u to 30w, the adjacent-unit control unit 14 causes air to be blown only from the flap closer to the space M than the suction port 33 among the four flaps 31a to 31d, and inhibits air from being blown out from other flaps. Note that in this alternative embodiment, for example, an arrangement information management table 22 shown in FIG. 8, instead of the arrangement information management table 21, is stored in the memory unit 20. Specifically, the arrangement information management table 22 manages information indicating the indoor units 30a, 30b, . . . , and 30y adjacent to each of the flaps 31a to 31d of each of the indoor units 30a, 30b, . . . , and 30y. Accordingly, the adjacent-unit control unit 14 can specify the flaps that can direct air to be blown toward the space M where the user requires air conditioning by referring to the arrangement information management table 22.

(5)

The above embodiment may be configured such that the user can select an “air curtain mode” in each of the indoor units 30a, 30b, . . . , and 30y via the remote controllers 40a, 40b, . . . , and 40y and the like.

In this case, the control unit 10 of the air conditioning control device 1 executes the following process instead of the process shown in FIG. 6.

Specifically, the control unit 10 causes the indoor units 30a, 30b, . . . , and 30y in which the user selected the “air curtain mode” via the remote controllers 40a, 40b, . . . , and 40y to perform the thermo-off operation, the mild cooling operation, or the mild heating operation, as in step S5 in FIG. 6 or the alternative embodiment (2). At this time, the direction of air from the indoor units 30a, 30b, . . . , and 30y in which the “air curtain mode” is selected is downward or obliquely downward in the direction toward the outside of the indoor units 30a, 30b, . . . , and 30y in which the “air curtain mode” is selected, or the direction of air is set to the swing mode where the air swings between these directions. In addition, as in step S5 in FIG. 6, a specific angle of the “obliquely downward” direction as referred to herein may be predetermined based on the distances among the indoor units 30a, 30b, . . . , and 30y, or may be automatically calculated by referring to the memory unit 20 in which information regarding these distances are stored in advance.

On the other hand, as for the indoor units 30a, 30b, . . . , and 30y in which a mode other than the “air curtain mode” (for example, the cooling operation mode or the heating operation mode) is selected by the user via the remote controllers 40a, 40b, . . . , and 40y, the control unit 10 performs control according to the settings of the operation mode, set temperature, air volume, direction of air, and the like that were input by the user via the remote controllers 40a, 40b, . . . , and 40y.

(6)

In the above embodiment, the following process instead of the process shown in FIG. 6 may be executed in the air conditioning control device 1.

Specifically, each of the indoor units 30a, 30b, . . . , and 30y may be controlled according to an output value of a suction temperature sensor attached near the suction port 33 of each of the indoor units 30a, 30b, . . . , and 30y. The control unit 35 of each of the indoor units 30a, 30b, . . . , and 30y causes the indoor units 30a, 30b, . . . , and 30y to perform the thermo-off operation, the mild cooling operation, or the mild heating operation, as in step S5 or the alternative embodiment (2), when it is determined based on an output value of the suction temperature sensor that cold air or warm air is flowing out from the space M that should be air conditioned. At this time, the direction of air is downward or obliquely downward in the direction toward the outside of the indoor units 30a, 30b, . . . , and 30y, or the direction of air is set to the swing mode where the air swings between these directions. Note that, as in step S5 in FIG. 6, a specific angle of the “obliquely downward” direction as referred to herein may be predetermined based on the distances among the indoor units 30a, 30b, . . . , and 30y, or may be automatically calculated by referring to the memory unit 20 in which information regarding these distances are stored in advance.

In addition, in step S5 of the above embodiment, the settings of the operation mode, set temperature, air volume, direction of air, and the like of the adjacent units 30a to 30c, 30i, 30n, 30s, and 30u to 30w may be adjusted according to an output value of the suction temperature sensor attached near the suction port 33 of each of the adjacent units 30a to 30c, 30i, 30n, 30s, and 30u to 30w.

(7)

The air conditioning control device 1 may be a central remote controller for the air conditioner including the indoor units 30a, 30b, . . . , and 30y. Consequently, the user can input an operation command to each of the indoor units 30a, 30b, . . . , and 30y via an input unit (not shown) of the air conditioning control device 1. Note that an operation command input via the input unit (not shown) of the air conditioning control device 1 is processed in the same manner as an operation command input via the remote controllers 40a, 40b, . . . , and 40y.

(8)

The above described alternative embodiments (1) to (6) may be combined in any manner.

### Second Embodiment

An air conditioning control device 101 according to a second embodiment of the present invention is described below. Note that the constituent elements common to the second embodiment and the first embodiment are denoted by the same reference symbols. The second embodiment is described below focusing on the difference from the first embodiment.

### <Installation Environment of Air Conditioning Control Device>

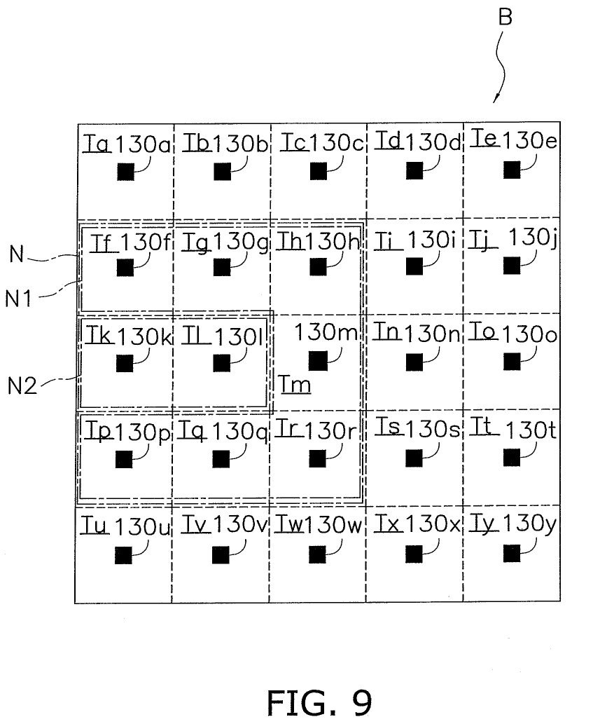

FIG. 9 shows the setting of an indoor space B where indoor units 130a, 130b, . . . , and 130y of an air conditioner controlled by the air conditioning control device 101 are installed. The indoor space B is a single large open space such as an office, restaurant, and the like.

In a ceiling of the indoor space B, the plurality of indoor units 130a, 130b, . . . , and 130y are embedded at appropriate intervals. In FIG. 9, cell spaces Ta, Th, . . . , and Ty partitioned by broken lines are spaces that are virtually divided, and are correspond to respectively for the indoor units 130a, 130b, . . . , and 130y. The cell spaces Ta, Tb, . . . , and Ty include the indoor units 130a, 130b, . . . , and 130y, respectively. In addition, the cell spaces Ta, Tb, . . . , and Ty are the target spaces to be air conditioned not only by the indoor units 130a, 130b, . . . , and 130y respectively included in those cell spaces Ta, Tb, . . . , and Ty but also by the indoor units 130a, 130b, . . . , and 130y included in the surrounding spaces Ta, Tb, . . . , and Ty. In other words, for example, the space to be targeted by the air conditioning operation of the air conditioning unit 130g is not only the cell space Tg but it also includes the cell spaces Ta to Tc, Tf, Th, and Tk to Tm surrounding the cell space Tg.

### <Configuration of the Air Conditioning Control Device>

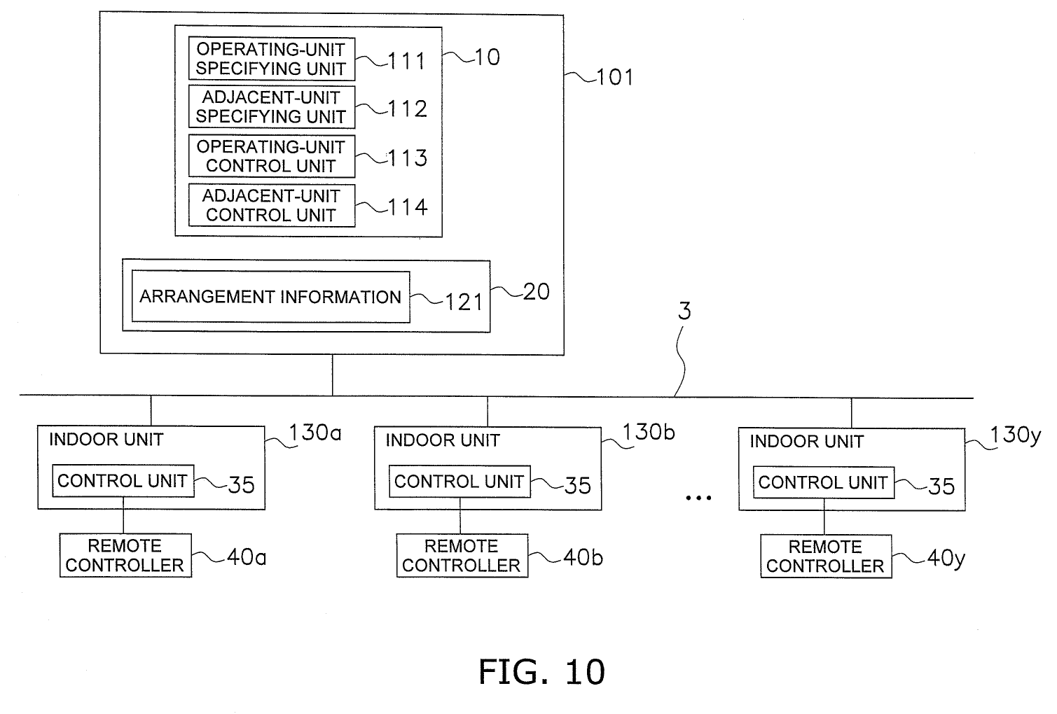

FIG. 10 is a block diagram showing the configuration of the air conditioning control device 101. The air conditioning control device 101 has the control unit 10 and the memory unit 20. The air conditioning control device 101 is connected to the control unit 35 of each of the indoor units 130a, 130b, . . . , and 130y via the communication network 3, and is capable of controlling the operation of each portion of each of the indoor units 130a, 130b, . . . , and 130y via the control unit 35.

By reading out and executing a control program stored in the memory unit 20, the control unit 10 operates as an operating-unit specifying unit 111, an adjacent-unit specifying unit 112, an operating-unit control unit 113, an adjacent-unit control unit 114 and the like. Details of the operation of each of these units 111 to 114 are described later.

The memory unit 20 stores arrangement information 121 that organizes information regarding the arrangement of the indoor units 130a, 130b, . . . , and 130y in the indoor space B. The arrangement information 121 is, for example, map information that mapped inside the indoor space B and has information that indicates the positional relationship of each of the indoor units 130a, 130b, . . . , and 130y.

### <Configuration of Air Conditioner>

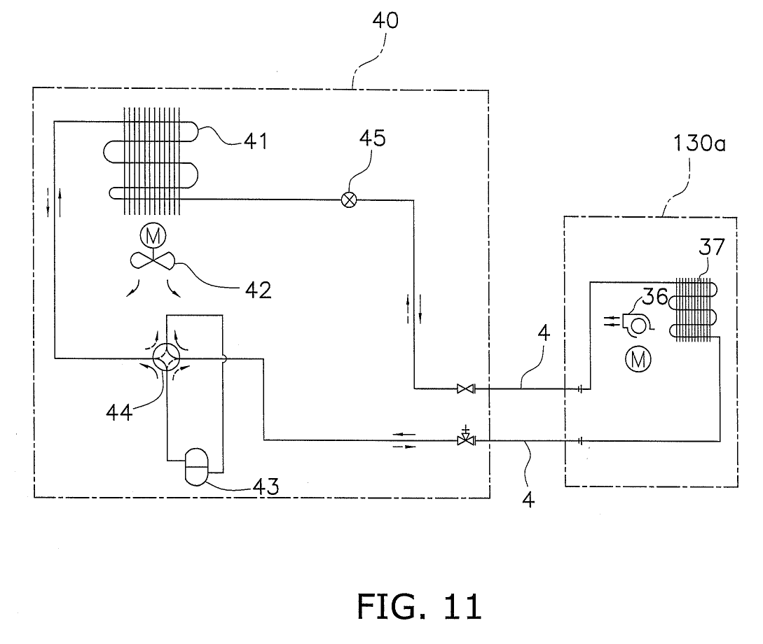

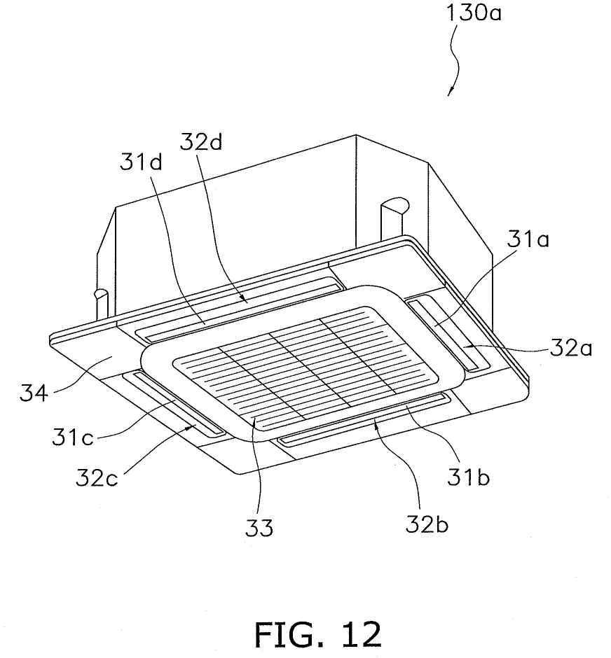

As shown in FIG. 11 and FIG. 12, the indoor unit 130a has the same configuration as the indoor unit 30a according to the first embodiment. In addition, the indoor units 130b, . . . , 130y also have the same configuration as the indoor units 30b, . . . , 30y according to the first embodiment.

### <Operation of Air Conditioning Control Device>

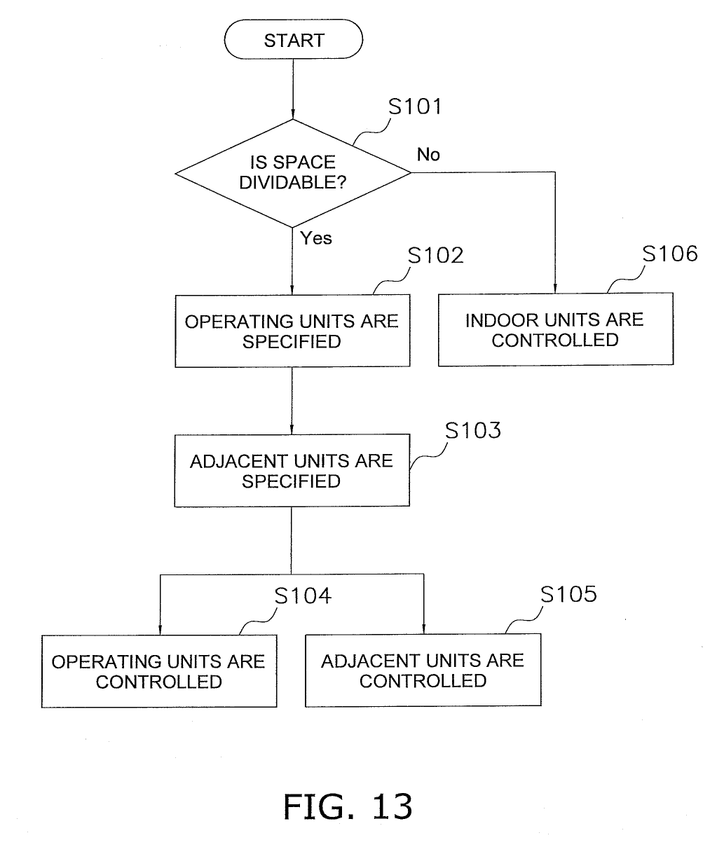

FIG. 13 is a flowchart showing the flow of the process in which the air conditioning control device 101 controls the indoor units 130a, 130b, . . . , and 130y of the air conditioner. This process is started when the user started or stopped any type of operation of the indoor units 130a, 130b, . . . , and 130y via the remote controllers 40a, 40b, . . . , and 40y (note that the operation in the air blowing mode where only blowing of air is performed is excluded, and the same applies throughout to the description of the second embodiment unless otherwise explicitly stated). The operation commands input into the remote controllers 40a, 40b, . . . , and 40y by the user are sent to the control unit 10 of the air conditioning control device 101 via the control unit 35 of the indoor units 130a, 130b, . . . , and 130y, respectively, and the communication network 3.

The process shown in FIG. 13 is described below by taking, as a specific example, the case in which the user requires air conditioning only in a space N (see FIG. 9) constituted by the cell spaces Tf to Th, Tk to Tm, and Tp to Tr within the indoor space B. In this specific example, the user selects the operation of the indoor units 130f to 130h, 130k to 130m, and 130p to 130r installed in the space N, among all the indoor units 130a, 130b, . . . , and 130y installed in the indoor space B, via the remote controllers 40a, 40b, . . . , and 40y. In other words, the space N is an air conditioning target space where the user requires air conditioning. For example, the space N is an occupied space where the user is present, and the cell spaces Ta to Te, Ti, Tj, Tn, To, Ts, Tt, and Tu to Ty that are not included in the space N are vacant spaces where the user is not present.

In step S101, based on the operation commands sent from the remote controllers 40a, 40b, . . . , and 40y, the control unit 10 specifies the indoor units 130f to 130h, 130k to 130m, and 130p to 130r being currently selected by the user to operate, among all the indoor units 130a, 130b, . . . , and 130y. Then, the control unit 10 refers to the arrangement information 121 stored in the memory unit 20 and specifies the space N for which the indoor units 130f to 130h, 130k to 130m, 130p to 130r that the user has selected to operate are arranged. Subsequently, the control unit 10 attempts to divide the space N where the user requires air conditioning into two blocks. The two blocks are: a boundary side space N1 that defines the boundary between the space N and the space outside thereof (cell spaces Ta to Te, Ti, Tj, Tn, To, Ts, Tt, and Tu to Ty); and an inner space N2 surrounded by the boundary side space N1. Then, when the control unit 10 succeeded in dividing the space N into the two blocks, in other words, when both the boundary side space N1 and the inner space N2 are present concurrently, the process proceeds to step S102, otherwise to step S106. In the case of the above described specific example, the process proceeds to step S102.

Next, in step S102, the control unit 10 operates as the operating-unit specifying unit 111. The operating-unit specifying unit 111 refers to the arrangement information 121 stored in the memory unit 20 and specifies the indoor units 130k and 130l (hereinafter referred to as the operating units) in the inner space N2 derived in step S101.

In step S103, the control unit 10 operates as the adjacent-unit specifying unit 112. The adjacent-unit specifying unit 112 refers to the arrangement information 121 stored in the memory unit 20 and specifies the indoor units 130f to 130h, 130m, and 130p to 130r (hereinafter referred to as the adjacent units) in the boundary side space N1 derived in step S101. Note that, because the boundary side space N1 and the inner space N2 are adjacently arranged, the adjacent units 130f to 130h, 130m, and 130p to 130r and the operating units 130k, and 130l are also adjacently arranged.

After step S103, the process proceeds to step S104 and step S105. Step S104 and step S105 are concurrently executed.

In step S104, the control unit 10 operates as the operating-unit control unit 113. The operating-unit control unit 113 controls the operating units 130k and 130l according to the settings of the operation mode, set temperature, air volume, direction of air, and the like that are input by the user via the remote controllers 40a, 40b, . . . , and 40y.

In addition, in step S105, the control unit 10 operates as the adjacent-unit control unit 114. The adjacent-unit control unit 114 causes the adjacent units 130f to 130h, 130m, and 130p to 130r specified in step S103 to perform the thermo-off operation, i.e., an operation in the air blowing mode where only blowing of air is performed. At this time, the direction of air from the adjacent units 130f to 130h, 130m, and 130p to 130r is downward or obliquely downward in the direction toward the outside, or the direction of air is set to a swing mode where the air swings between these directions. Note that a specific angle of the “obliquely downward” direction as referred to herein may be predetermined based on the distances among the indoor units 130a, 130b, . . . , and 130y, or may be automatically calculated by referring to the memory unit 20 in which information regarding these distances are stored in advance. Or, the direction of air from the adjacent units may be determined according to the setting of the operating units 130k and 130l. For example, if the setting of the operating units 130k and 130l is “downward”, the direction of air from the adjacent units is adjusted to be more downward. Further, the air volume of the adjacent units may be uniformly set to, for example, “strong” or may be determined according to the setting of the operating units 130k and 130l. For example, if the setting of the operating units 130k and 130l is “strong,” the air volume of the adjacent units may be set to “strong”, and if the setting of the operating units 130k and 130l is “weak,” the air volume of the adjacent units may be set to “weak”.

Accordingly, in this step S105, it is possible to inhibit air conditioned by the operating units 130k and 130l in the space N where the user requires air conditioning from diffusing from the space N where the user requires air conditioning.

Note that the indoor units 130a to 130e, 130i, 130j, 130n, 130o, 130s, 130t, and 130u to 130y that are neither the operating units 130k and 130l specified by the operating-unit specifying unit 111 nor the adjacent units 130f to 130h, 130m, and 130p to 130r specified by the adjacent-unit specifying unit 112 are held in the OFF state unless the operation in the air blowing mode is selected by the user.

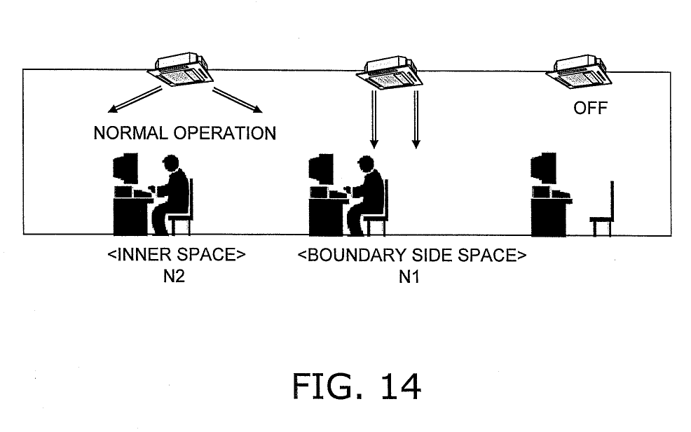

FIG. 14 is a view showing the setting of the indoor space B during execution of step S104 and step S105 in the above described specific example.

Note that when the process proceeds to step S106 after step S101, each of the indoor units 130a, 130b, . . . , and 130y in the indoor space B will be controlled according to the settings of the operation mode, set temperature, air volume, direction of air, and the like that were input by the user via the remote controllers 40a, 40b, . . . , and 40y.

### <Characteristics>

In the above embodiment, when the user issues a command that only some indoor units 130f to 130h, 130k to 130m, and 130p to 130r should perform the air conditioning operation in the single large open indoor space B where the plurality of indoor units 130a, 130b, . . . , and 130y are installed, the indoor units 130f to 130h, 130m, and 130p to 130r in the boundary side space N1 perform the air blowing operation, and thereby the space N that should be air conditioned will be enveloped by an air curtain. The boundary side space N1 is a space that defines the boundary between the space N and the space outside thereof (cell spaces Ta to Te, Ti, Tj, Tn, To, Ts, Tt, and Tu to Ty) in the space N side. Accordingly, the conditioned air is inhibited from diffusing from the space N that should be air conditioned, and thereby it is possible to achieve energy conservation.

### Alternative Embodiments

(1)

In the above embodiment, in step S105 in FIG. 13, the adjacent units 130f to 130h, 130m, and 130p to 130r are controlled to perform the thermo-off operation; however, they may be controlled to perform the mild cooling operation or the mild heating operation. In this case, the mild cooling operation or the mild heating operation of the adjacent units 130f to 130h, 130m, and 130p to 130r will aid the cooling operation or the heating operation in the space N where the user requires air conditioning.

(2)

In the above embodiment, a location identifying system capable of automatically detecting the location of a living body such as a person or an animal present in the indoor space B may be introduced. For example, as such a location identifying system, infrared sensors may be installed at several appropriate locations in the indoor space B. Or, a living body in the indoor space B may carry a transmitter, and receivers capable of detecting a signal from the transmitter may be installed in several appropriate locations in the indoor space B. Additionally, as a transmitter, a device such as an IC tag may be used. If a transmitter and receivers are introduced as the location identifying system, the control unit 10 and the like will identify the location of the transmitter by triangulation or other methods based on a signal from the transmitter that was received by the receivers. Further, mainly in the case where the indoor space B is an office or the like, an entering/leaving management system introduced as the location identifying system into the indoor space B, or a personal computer used by an employee working in the indoor space B which allows manual input of information indicating the presence or absence of people may be used by interlocking with the air conditioning control device 101.

In this case, information regarding the location of a living body identified by such a location identifying system is sent to the control unit 10 of the air conditioning control device 101. Then, in step S102 in FIG. 13, the operating-unit specifying unit 111 specifies the operating units and adjacent units based on the information regarding the location of the living body identified by the location identifying system in addition to or instead of the operation commands sent from the remote controllers 40a, 40b, . . . , and 40y. Additionally, in this case, the process in FIG. 13 may be executed in the case where the information regarding the location of the living body is sent to the control unit 10 from the location identifying system in addition to or instead of the case where the operation commands input by the user are sent to the control unit 10 from the remote controllers 40a, 40b, . . . , and 40y.

(3)

In the above embodiment, opening and closing of the flaps 31a to 31d of each of the indoor units 130a, 130b, . . . , and 130y may be independently controllable for each of the flaps 31a to 31d.

In this case, the thermo-off operation of the adjacent units 130f to 130h, 130m, and 130p to 130r in step S105 in FIG. 13 may be controlled as described below.

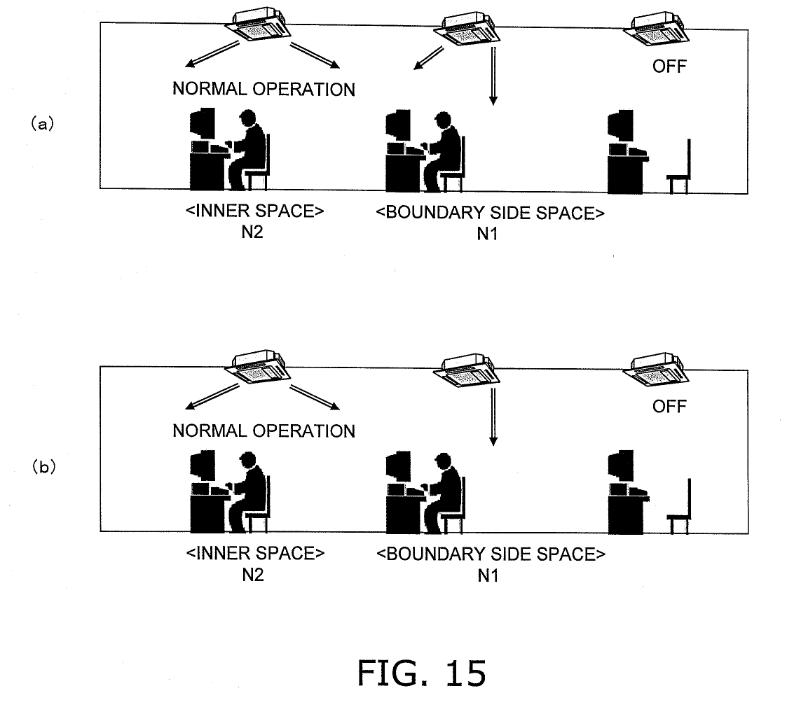

Specifically, the adjacent-unit control unit 114 causes air to be blown out in different directions from the four flaps 31a to 31d of each of the adjacent units 130f to 130h, 130m, and 130p to 130r. Consequently, for example, air is blown out downward from each flap farther from the inner space N2 than the suction port 33 (i.e., flaps closer to the cell spaces Ta to Te, Ti, Tj, Tn, To, Ts, Tt, and Tu to Ty that are not the air conditioning target spaces), and air is blown out obliquely downward from each flap closer to the inner space N2 than the suction port 33 (i.e, flaps farther from the cell spaces Ta to Te, Ti, Tj, Tn, To, Ts, Tt, and Tu to Ty that are not the air conditioning target spaces) (see FIG. 15(a)). Or, among the four flaps 31a to 31d of each of the adjacent units 130f to 130h, 130m, and 130p to 130r, air is blown out only from the flap farther from the inner space N2 than the suction port 33 (i.e., flaps closer to the cell spaces Ta to Te, Ti, Tj, Tn, To, Ts, Tt, and Tu to Ty that are not the air conditioning target spaces) (see FIG. 15(b)). At this time, air is not blown out from each flap closer to the inner space N2 than the suction port 33 (i.e., flaps farther from the cell spaces Ta to Te, Ti, Tj, Tn, To, Ts, Tt, and Tu to Ty that are not the air conditioning target spaces).

Note that in this alternative embodiment, for example, the arrangement information 121 stored in the memory unit 20 has information indicating the position of each of the flaps 31a to 31d of each of the indoor units 130a, 130b, . . . , and 130y. Accordingly, the adjacent-unit control unit 114 can refer to the arrangement information 121 and specify the flap closer to or farther from the inner space N2 than the suction port 33.

(4)

In step S105 of the above embodiment, the settings of the operation mode, set temperature, air volume, direction of air, and the like of the adjacent units 130f to 130h, 130m, and 130p to 130r may be adjusted according to an output value of a suction temperature sensor attached near the suction port 33 of each of the adjacent units 130f to 130h, 130m, and 130p to 130r.

(5)

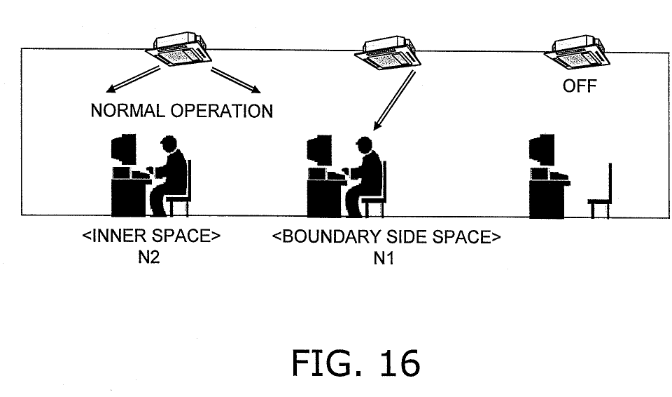

In the above embodiment, when the cooling mode is selected by the user, the adjacent-unit control unit 114 may perform control such that the direction of air blowing from each of the adjacent units 130f to 130h, 130m, and 130p to 130r is directed toward a living body such as a person or an animal present in the boundary side space N1 (see FIG. 16). Note that, in the example shown in FIG. 16, opening and closing of each of the flaps 31a to 31d of each of the indoor units 130a, 130b, . . . , and 130y are independently controllable, as in the alternative embodiment (3). In this case, a location identifying system capable of automatically detecting the location of a living body present in the indoor space B may be connected to the air conditioning control device 101. Such a location identifying system includes the examples described in the alternative embodiment (2). Information regarding the location of a living body identified by such a location identifying system is sent to the control unit 10 of the air conditioning control device 101. Additionally, in step S105 in FIG. 13, the adjacent-unit control unit 114 controls the direction of air from each of the adjacent units 130f to 130h, 130m, and 130p to 130r based on the information regarding the location of the living body identified by the location identifying system.

In the above embodiment, because the adjacent units 130f to 130h, 130m, and 130p to 130r do not perform the operation as selected by the user, there is a risk that the temperature in the boundary side space N1 for which the adjacent units 130f to 130h, 130m, and 130p to 130r are arranged may become high, thus impairing comfort. Therefore, in this alternative embodiment, when the operating units 130k and 130l perform the cooling operation, each of the adjacent units 130f to 130h, 130m, and 130p to 130r is caused to blow out air toward a living body present in the vicinity of each of the adjacent units 130f to 130h, 130m, and 130p to 130r, respectively. In other words, in this alternative embodiment, the adjacent units 130f to 130h, 130m, and 130p to 130r play a role as a fan. Thereby, an air flow in the boundary side space N1 is facilitated, and a difference between the sensible temperature as felt by a living body in the boundary side space N1 and the sensible temperature as felt by a living body in the inner space N2 is reduced, and the above described problem is eliminated.

In addition, in this alternative embodiment, a temperature difference between the boundary side space N1 where the adjacent units 130f to 130h, 130m, and 130p to 130r are installed and the cell spaces Ta to Te, Ti, Tj, Tn, To, Ts, Tt, and Tu to Ty that are not the air conditioning target spaces does not become too large, thus inhibiting cold air from diffusing from the space N.

Further, a difference between the sensible temperature as felt by a living body in the boundary side space N1 (cell spaces Tf to Th, Tm, and Tp to Tr) and the sensible temperature as felt by a living body in the inner space N2 (cell spaces Tk and TI) may be converted into an index and measured, and the direction of air from each of the adjacent units 130f to 130h, 130m, and 130p to 130r may be controlled by the adjacent-unit control unit 114 such that the difference with respect to the sensible temperature is equal to or lower than a predetermined value. In this case, when the difference with respect to the sensible temperature cannot be maintained equal to or lower than a predetermined value, control may be performed so as to increase the performance levels of the operating units 130k and 130l or the performance levels of the adjacent units 130f to 130h, 130m, and 130p to 130r, or the performance levels of both these operating units and adjacent units. Note that the difference with respect to the sensible temperature can be converted into an index based on an output value of the suction temperature sensor attached near the suction port 33 of each of the adjacent units 130f to 130h, 130m, and 130p to 130r and each of the operating units 130k and 130l as well as information regarding preference of the user for the draft feeling and the like. In addition, instead of the difference with respect to the sensible temperature, comfort in the boundary side space N1 (cell spaces Tf to Th, Tm, and Tp to Tr) may be converted into an index and measured. Note that the comfort can be converted into an index based on an output value of the suction temperature sensor attached near the suction port 33 of each of the adjacent units 130f to 130h, 130m, and 130p to 130r as well as information regarding preference of the user for the draft feeling and the like.

(6)

In the above embodiment, when the cooling mode is selected by the user, the adjacent-unit control unit 114 may perform control such that the air volume of each of the adjacent units 130f to 130h, 130m, and 130p to 130r becomes greater than a set value that the user selected for each of the adjacent units 130f to 130h, 130m, and 130p to 130r. Or, control may be performed such that the air volume of each of the adjacent units 130f to 130h, 130m, and 130p to 130r becomes greater than a set value selected for each of the operating units 130k and 130l by a predetermined level. Or, control may be performed such that the air volume of each of the adjacent units 130f to 130h, 130m, and 130p to 130r is set to a maximum air volume.

In the above embodiment, because the adjacent units 130f to 130h, 130m, and 130p to 130r do not perform the operation as selected by the user, there is a risk that the temperature in the boundary side space N1 for which the adjacent units 130f to 130h, 130m, and 130p to 130r are arranged may become high, thus impairing comfort. Therefore, in this alternative embodiment, when the operating units 130k and 130l perform the cooling operation, the air volume of each of the adjacent units 130f to 130h, 130m, and 130p to 130r is increased. In other words, in this alternative embodiment, an air flow in the boundary side space N1 is facilitated, and a difference between the sensible temperature as felt by a living body in the boundary side space N1 and the sensible temperature as felt by a living body in the inner space N2 is reduced, and the above described problem is eliminated.

In addition, in this alternative embodiment, a temperature difference between the boundary side space N1 where the adjacent units 130f to 130h, 130m, and 130p to 130r are installed and the cell spaces Ta to Te, Ti, Tj, Tn, To, Ts, Tt, and Tu to Ty that are not the air conditioning target spaces does not become too large, thus inhibiting cold air from diffusing from the space N.

Further, a difference between the sensible temperature as felt by a living body in the boundary side space N1 (cell spaces Tf to Th, Tm, and Tp to Tr) and the sensible temperature as felt by a living body in the inner space N2 (cell spaces Tk and Ti) may be converted into an index and measured, and the air volume of each of the adjacent units 130f to 130h, 130m, and 130p to 130r may be controlled by the adjacent-unit control unit 114 such that the difference with respect to the sensible temperature is equal to or lower than a predetermined value. In this case, when the difference with respect to the sensible temperature cannot be maintained equal to or lower than a predetermined value, control may be performed so as to increase the performance levels of the operating units 130k and 130l or the performance levels of the adjacent units 130f to 130h, 130m, and 130p to 130r, or the performance levels of both these operating units and adjacent units. Note that the difference with respect to the sensible temperature can be converted into an index based on an output value of the suction temperature sensor attached near the suction port 33 of each of the adjacent units 130f to 130h, 130m, and 130p to 130r and each of the operating units 130k and 130l as well as information regarding preference of the user for the draft feeling and the like. In addition, instead of the difference with respect to the sensible temperature, comfort in the boundary side space N1 (cell spaces Tf to Th, Tm, and Tp to Tr) may be converted into an index and measured. Note that the comfort can be converted into an index based on an output value of the suction temperature sensor attached near the suction port 33 of each of the adjacent units 130f to 130h, 130m, and 130p to 130r as well as information regarding preference of the user for the draft feeling and the like.

(7)

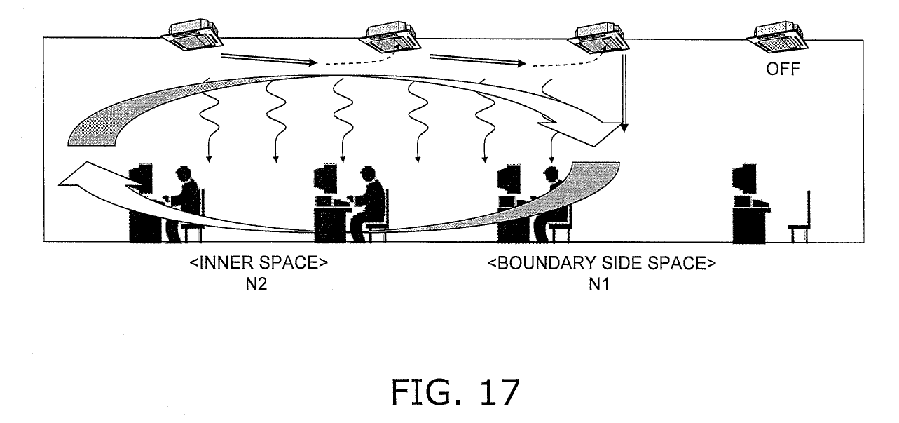

In the above embodiment, when the cooling mode is selected by the user, the operating-unit control unit 113 may perform control such that the direction of air blowing from each of the operating units 130k and 130l is directed toward the adjacent units 130f to 130h, 130m, and 130p to 130r (see FIG. 17). In this case, the direction of air from each of the operating units 130k and 130l is substantially horizontal, and an air flow is formed near the ceiling of the space N which moves along the ceiling in a hovering manner. Accordingly, cold air that tends to easily accumulate on the lower side can easily accumulate near the ceiling of the space N, and cold air blown out from the operating units 130k and 130l is prevented from immediately diffusing toward around the floor of the space N. Instead, cold air accumulated near the ceiling will gradually diffuse toward around the floor. Therefore, in this alternative embodiment, the entire space N can be uniformly cooled.

Note that, in the example shown in FIG. 17, as in the alternative embodiment (3), opening and closing of each of the flaps 31a to 31d of each of the indoor units 130a, 130b, . . . , and 130y is independently controllable, and control is performed such that an air flow from each of the flaps 31a to 31d of each of the operating units 130k and 130l is prevented from colliding with each other. As a result, an air flow that moves along the ceiling of the space N in a hovering manner easily flows from the operating units 130k and 130l toward the adjacent units 130f to 130h, 130m, and 130p to 130r. Then, cold air from the operating units 130k and 130l is merged with an air flow flowing downward or obliquely downward from the adjacent units 130f to 130h, 130m, and 130p to 130r, thus forming a circulating air flow in the space N. Accordingly, it is possible to uniformly cool the entire space N.

Further, in the example shown in FIG. 17, each of the adjacent units 130f to 130h, 130m, and 130p to 130r is controlled by the adjacent-unit control unit 114 as described below. Specifically, among each of the flaps 31a to 31d of each of the adjacent units 130f to 130h, 130m, and 130p to 130r, the adjacent-unit control unit 114 stops air blowing from the flap on the side close to the operating units 130k and 130l and causes air to be blown out only from the flap farther from the inner space N2 than the suction port 33. Accordingly, each of the adjacent units 130f to 130h, 130m, and 130p to 130r can easily suck cold air from each of the operating units 130k and 130l via the suction port 33, and the cold air is blown out from the adjacent units 130f to 130h, 130m, and 130p to 130r. Thereby, cold air generated in the operating units 130k and 130l reaches throughout the space N.

Further, in this alternative embodiment, as in the alternative embodiments (5) and (6), the adjacent-unit control unit 114 may control the direction of air from and the air volume of each of the adjacent units 130f to 130h, 130m, and 130p to 130r based on a difference between the sensible temperature as felt by a living body in the boundary side space N1 and the sensible temperature as felt by a living body in the inner space N2 and/or the comfort in the boundary side space N1. Consequently, it is possible to form a circulating air flow in the space N while directing air blown from the adjacent units 130f to 130h, 130m, and 130p to 130r toward the living body in the boundary side space N1.

(8)

The air conditioning control device 101 may be a central remote controller for the air conditioner that includes the indoor units 130a, 130b, . . . , and 130y. Consequently, the user can input an operation command to each of the indoor units 130a, 130b, . . . , and 130y via an input unit (not shown) of the air conditioning control device 101. Note that an operation command input via the input unit (not shown) of the air conditioning control device 101 is processed in the same manner as an operation command input via the remote controllers 40a, 40b, . . . , and 40y.

(9)

The above described alternative embodiments (1) to (6) may be combined in any manner.

### INDUSTRIAL APPLICABILITY

The present invention has effects that can improve the air conditioning operational efficiency in the space of a portion of a single space having an indoor unit group installed when air conditioning is needed only in the space of the portion, and can facilitate energy conservation. The present invention is useful as an air conditioning control device and an air conditioning control method in which the operation of the indoor unit group constituted by a plurality of indoor units of an air conditioner installed in the single space is collectively controlled.

1. An air conditioning control device adapted to collectively control operation of an indoor unit group including by a plurality of indoor units of an air conditioner installed in a single space, the air conditioning control device comprising:
an operating-unit specifying unit configured to specify an operating unit from the indoor units included in the indoor unit group, the operating unit performing an air conditioning operation;
an adjacent-unit specifying unit configured to specify an adjacent unit from the indoor units included in the indoor unit group, the adjacent unit being adjacent to the operating unit;
an operating-unit control unit configured to cause the operating unit to perform the air conditioning operation; and
an adjacent-unit control unit configured to cause the adjacent unit to perform an air flow generating operation to generate an air flow that inhibits air conditioned by the air conditioning operation of the operating unit from diffusing from an air conditioning target space forming a portion of the single space and which is targeted by the air conditioning operation of the operating unit.

2. The air conditioning control device according to claim 1, wherein the air flow generating operation is a thermo-off operation.

3. The air conditioning control device according to claim 1, wherein
the air flow generating operation is a mild cooling operation or a mild heating operation.

4. The air conditioning control device according to of claim 1, wherein
the adjacent unit is installed in a ceiling of the single space, and
the air flow generating operation is an air blowing operation to blow air downward or obliquely downward.

5. The air conditioning control device according to one of claim 1, further comprising
an operation command input unit configured to allow a user to input an operation command to the indoor units included in the indoor unit group, wherein
the operating-unit specifying unit is configured to specify the operating unit based on the operation command input via the operation command input unit.

6. The air conditioning control device according to of claim 1, further comprising
a living body location identifying unit configured to identify a location of a living body present in the single space, wherein
the operating-unit specifying unit is configured to specify the operating unit based on the location of the living body identified by the living body location identifying unit.

7. The air conditioning control device according to of claim 1, wherein
the adjacent unit includes a plurality of air blow-out direction adjusting elements configured to adjust a direction of air blown out therefrom, and
the air flow generating operation is an operation to generate the air flow by independently controlling the plurality of air blow-out direction adjusting elements such that the adjacent unit blows out air only in a direction toward the air conditioning target space.

8. The air conditioning control device according to claim 1, wherein,
a plurality of indoor units are specified as operating units by the operating-unit specifying unit, and the adjacent-unit specifying unit is configured to specify only an indoor unit that is not one of the operating units as the adjacent unit from all the indoor units adjacent to at least one of the operating units, and
the operating-unit control unit is configured to cause an operating unit adjacent to the adjacent unit to perform the air conditioning operation at reduced performance level compared to an operating unit not adjacent to the adjacent unit.

9. The air conditioning control device according to claim 1 further comprising
a memory unit configured to store arrangement information regarding an arrangement of the indoor units included in the indoor unit group in the single space, wherein
the adjacent-unit specifying unit is configured to specify the adjacent unit based on the arrangement information stored in the memory unit.

10. The air conditioning control device according to claim 1, wherein
the operating unit and the adjacent unit are present in the air conditioning target space.

11. The air conditioning control device according to claim 10, wherein
the operating-unit control unit is configured to cause the operating unit to perform a cooling operation, and
the adjacent-unit control unit is configured to control a direction of air flow from the adjacent unit to be directed toward a living body in a vicinity of the adjacent unit.

12. The air conditioning control device according to claim 10, wherein
the adjacent unit is installed in a ceiling of the singe space,
the operating-unit control unit is configured to cause the operating unit to perform a cooling operation, and
the operating-unit control unit is configured to control a direction of air flow from the operating unit to be directed toward the adjacent unit.

13. The air conditioning control device according to claim 10, wherein
the adjacent unit includes a suction port configured to suck air and a plurality of air blow-out direction adjusting elements configured to adjust a direction of air blown out therefrom, and
the air flow generating operation is an operation to generate the air flow only from the air blow-out direction adjusting elements farther from the operating unit than the suction port.

14. An air conditioning control method for collectively controlling operation of an indoor unit group including a plurality of indoor units of an air conditioner installed in a single space, the air conditioning control method comprising:
specifying an operating unit from the indoor units included in the indoor unit group, the operating unit performing an air conditioning operation;
specifying an adjacent unit from the indoor units included in the indoor unit group, the adjacent unit being adjacent to the operating unit;
controlling the operating unit such that the operating unit performs the air conditioning operation; and
controlling the adjacent unit such that the adjacent unit performs an air flow generating operation to generate an air flow that inhibits air conditioned by the air conditioning operation of the operating unit from diffusing from an air conditioning target space forming a portion of the single space and which is targeted by the air conditioning operation of the operating unit.

15. The air conditioning control device according to claim 2, wherein
the adjacent unit is installed in a ceiling of the single space, and
the air flow generating operation is an air blowing operation to blow air downward or obliquely downward.

16. The air conditioning control device according to claim 3, wherein
the adjacent unit is installed in a ceiling of the single space, and
the air flow generating operation is an air blowing operation to blow air downward or obliquely downward.

17. The air conditioning control device according to claim 5, further comprising
a living body location identifying unit configured to identify a location of a living body present in the single space, wherein
the operating-unit specifying unit is configured to specify the operating unit based on the location of the living body identified by the living body location identifying unit.

18. The air conditioning control device according to claim 17, wherein
the adjacent unit includes a plurality of air blow-out direction adjusting elements configured to adjust a direction of air blown out therefrom, and
the air flow generating operation is an operation to generate the air flow by independently controlling the plurality of air blow-out direction adjusting elements such that the adjacent unit blows out air only in a direction toward the air conditioning target space.

19. The air conditioning control device according to claim 18, wherein,
a plurality of indoor units are specified as operating units by the operating-unit specifying unit, and the adjacent-unit specifying unit is configured to specify only an indoor unit that is not one of the operating units as the adjacent unit from all the indoor units adjacent to at least one of the operating units, and
the operating-unit control unit is configured to cause an operating unit adjacent to the adjacent unit to perform the air conditioning operation at reduced performance level compared to an indoor unit not adjacent to the adjacent unit.

20. The air conditioning control device according to claim 19 further comprising
a memory unit configured to store arrangement information regarding an arrangement of the indoor units included in the indoor unit group in the single space, wherein
the adjacent-unit specifying unit is configured to specify the adjacent unit based on the arrangement information stored in the memory unit.
